(19) United States
(12) Patent Application Publication
(10) Pub. No.: US 2012/0264012 A1
(43) Pub. Date: Oct. 18, 2012

(54) ELECTRODE AND A PRODUCTION METHOD THEREFOR

(75) Inventors: Gyu-Bong Cho, Jinju-si (KR); Jung-Pil Noh, Masan-si (KR); Hyo-Jun Ahn, Jinju-si (KR); Ki-Won Kim, Jinju-si (KR); Tae-Hyeon Nam, Jinju-si (KR)

(73) Assignee: Industry-Academic Cooperation Foundation Gyeongsang National University, Gyeongsangnam-do (KR)

(21) Appl. No.: 13/502,203

(22) PCT Filed: Nov. 25, 2009
(86) PCT No.: PCT/KR2009/006984

§ 371 Date: Jun. 27, 2012

(30) Foreign Application Priority Data
Oct. 15, 2009 (KR) 10-2009-0098305

(51) Int. Cl. H01M 4/04; H01M 4/62; H01M 4/02

(52) U.S. Cl. 429/209; 252/512

(57) ABSTRACT

Disclosed is an electrode. The electrode comprises an active material in the form of a powder, and an electrically conductive material based on a shape-memory alloy. Consequently, damage to the electrode can be minimised and electrode life is improved.

### TECHNICAL FIELD

The present invention relates to an electrode and a method for fabricating the same, and more particularly, to an electrode which uses a shape-memory alloy as a conductive material and a method for fabricating the same.

### BACKGROUND ART

The recent development in the electronic and telecommunications industries has led into rapid growth of the electronic apparatuses supported by improved portability, compactness and light-weight, and high-performance. High-performance lithium secondary battery is employed as a power source of these portable electronic apparatuses, and demands are fast increasing. The secondary battery, which repeats charging and discharging, will be the essential power source of the portable electronic devices for telecommunications, electric bikes, electric cars, etc. Demands for higher-performance batteries are considerably high, because the performance of the electronic apparatuses heavily depends on the batteries which are the core parts of the electronic apparatuses. Batteries have to meet various required aspects including charge/discharge characteristic, cycle life, rate capability, or stability at high temperature, and the lithium secondary batteries are the most widely used. The secondary battery generally includes anode-cathode active materials, a conductive material to improve conductivity between active materials, a current collector to construct circuit, and electrolyte.

The secondary battery is receiving most attention for its high voltage and energy density. Depending on the electrolyte, the secondary battery is sometimes categorized into liquid type battery which uses liquid, gel type battery which uses mixture of liquid and polymer, and solid type polymer battery which purely uses polymer.

Meanwhile, the Si, Sn, Al, Ge, metal sulfide of the electrode of a conventional lithium battery causes variation in the volume of the electrode in reaction with the lithium during discharge, to thus cause damage to the electrode.

### DISCLOSURE

### Technical Problem

Accordingly, an object of the present invention is to provide an electrode in which damage is minimized due to use of shape memory alloy as a conductive material, and a fabricating method thereof.

### Technical Solution

In order to achieve the above-mentioned object, an electrode may be provided, which may include a powdered active material, and a conductive material of a shape memory alloy family.

The electrode may additionally include at least one of a binder and a conductive material without shape memory effect.

The active material may be formed such that one of the powdered active material and the conductive material is coated on an external surface of the other.

The active material may be formed such that one of the powdered active material and the conductive material is dispersed and included within the other.

The active material may be formed such that the conductive material without shape memory effect is formed at least one of interior and exterior thereof.

The electrode may be used for a lithium or alkali battery.

Meanwhile, a method for fabricating an electrode for use in a lithium battery is provided, which may include mixing a powdered active material and a conductive material of a shape memory alloy family, and forming an electrode layer using the mixed materials.

The mixing may include adding at least one of a binder and a conductive material without shape memory effect.

The active material may have at least one of a form in which one of the powdered active material and the conductive material is coated on an external surface of the other, and a form in which one of the powdered active material and the conductive material is dispersed and included within the other.

The active material may be formed such that the conductive material without shape memory effect is formed at least one of interior and exterior thereof.

### Advantageous Effects

Accordingly, damages to electrode due to volume variation in response to reaction with the metals of the battery are minimized, and the life cycle of the electrode is enhanced.

### BRIEF DESCRIPTION OF DRAWINGS

FIGS. 1 and 2 are vertical cross-section views of an electrode for use in battery according to an embodiment of the present invention.

FIGS. 3 and 4 are vertical cross-section views of an electrode for use in battery according to another embodiment of the present invention.

FIG. 5 is a view illustrating constitution of a composition of an electrode layer according to an embodiment of the present invention.

FIGS. 6 and 7 are views provided to explain constitution of a composition of an electrode layer according to another embodiment of the present invention.

FIGS. 8 and 9 are views provided to explain constitution of a composition of an electrode layer according to yet another embodiment of the present invention.

FIGS. 10 to 12 are views illustrating constitution of an electrode for use in battery according to various embodiments of the present invention.

FIG. 13 is a flowchart provided to explain a process for fabricating an electrode according to an embodiment of the present invention.

FIG. 14 is a view illustrating a structure of a battery according to an embodiment of the present invention.

### BEST MODE

### Mode for Invention

The present invention will be explained in greater detail below with reference to the accompanying drawings.

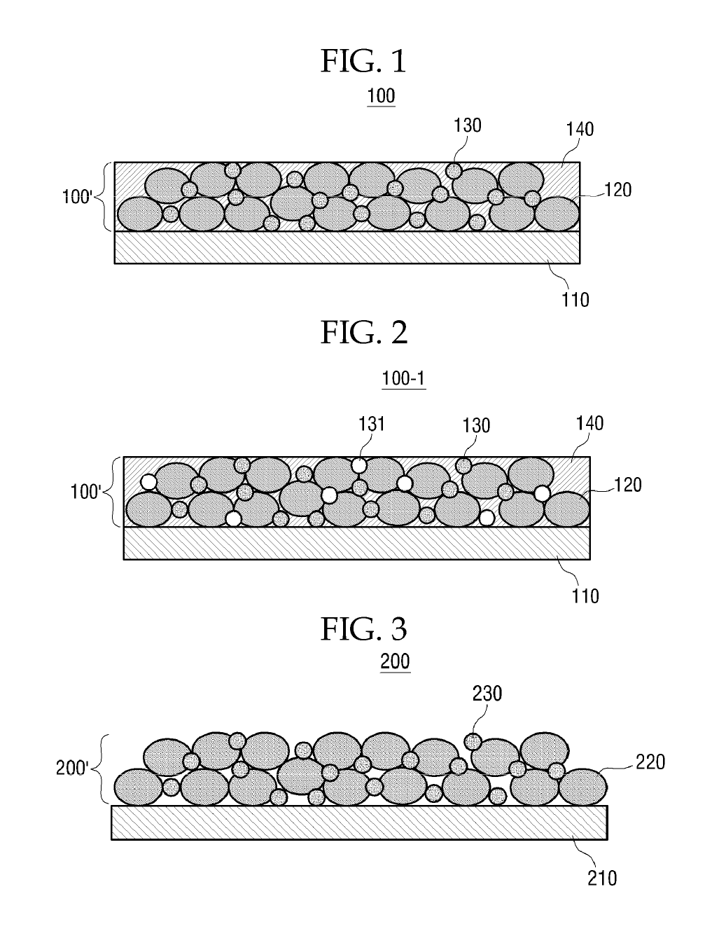

FIGS. 1 and 2 are vertical cross-section views of an electrode for use in battery according to an embodiment of the present invention.

Referring to FIG. 1, an electrode 100 includes a current collector 110, an active material 120, a conductive material 130 and a binder 140.

The electrode 100 may be used for a primary or secondary battery. The electrode 100 may further be used for lithium battery, alkali battery, or acid battery. As used herein, the ‘alkali battery’ refers to a battery that uses group 1 or 2 alkali metals. By way of example, a battery may use the group 1 elements including H (hydrogen), Na (sodium), K (potassium), Rb (rubidium), Cs (cesium), Fr (francium), or the group 2 elements including Be (beryllium), Mg (magnesium), Ca (calcium), Sr (strontium), Ba (barium), Ra (Radium), or Ni (nickel) or Pb (lead). Lithium is also one of the alkali metals, but will be separately named as lithium battery in the present description as is generally called. Meanwhile, the acid battery may include lead acid battery.

For convenience of explanation, an embodiment will be explained below with reference to an example where an electrode 100 for use in battery according to an embodiment is applied in lithium battery. However, the embodiment may be applied equally to the batteries using metals other than lithium, except for the difference of constitution which may vary depending on the unique properties of the metals used.

The current collector 110 forms flow of electrons between the electrode active material and the battery terminal. The current collector is not strictly limited. That is, any current collector with high enough conductivity may be implemented, as long as it does not induce chemical change in the battery.

The current collector 110 may be selected from the group consisting of, for example, but not limited to, copper, nickel, stainless steel, titanium, aluminum, carbon-coated aluminum, nickel foam, polymer substrate coated with conductive metal, and a combination thereof. Depending on embodiments, the above-mentioned materials may be processed into foamed, meshed, conductive material-coated, or punched form, but not limited thereto. Alternatively, the above-mentioned material may be used, with at least one surface being coated with another material.

Meanwhile, the active material particles (or powder) 120, conductive material particles (or powder) 130, and binder 140 may be mixed into slurry to form the electrode layer 100′. Depending on examples, the binder may be omitted so that only the active material particles 120 and the conductive material particles 130 may form the electrode layer 100′. This will be explained in greater detail below.

Any material with reversible reaction to lithium may be used as the active material 120.

When the electrode 100 is used as cathode, the active material 120 may be a material with reversible reaction to lithium, a material to form a compound with lithium metal reversibly, one selected from the group consisting of C, Na, K, Rb, Cs, Fr, Be, Mg, Ca, Sr, Ba, Ra, Ti, Ag, Zn, Cd, Al, Ga, In, Si, Ge, Sn, Pb, Sb, Ni, Bi, or a combination thereof, or oxide or nitride thereof. Further, a cathode active material containing the above materials and the lithium alloy may be used. A material with lithium elimination (decomposition) reaction to lithium ranging below 2.5V (Li/Li⁺) may be used.

Carbon is one of the materials that have reversible reaction to lithium, and any carbon cathode active material generally used in lithium secondary battery may be used. Representative example of the material includes crystalline carbon, amorphous carbon, or both.

Meanwhile, when the electrode 100 is used as the anion of the battery, any compound with reversible reaction to lithium may be unlimitedly used as the anion active material. By way of example, at least one may be selected from the group consisting of Ni₃Si, LiMn₂O₄, LiCoO₂, LiNiO₂, LiFeO₂, V₂O₅, LiFePO₄, metal sulfide, sulfur, etc. and used.

Depending on embodiments, the active material may have a coating layer on the surface thereof, or a compound containing active material and coating layer may be mixed to be used. The coating layer may include at least one coating element compound selected from the group consisting of oxide of the coating element, hydroxide, oxyhydroxide of the coating element, oxycarbonate of the coating element, and hydroxycarbonate of the coating element. These compounds that form the coating layer may be crystalline or amorphous. Further, the coating element contained in the coating layer may be selected from the group consisting of Li, Mg, Al, Co, K, Na, Ca, Si, Ti, V, Sn, Ge, Ga, B, As, Zr, and a combination thereof, or oxide or nitride thereof may be used.

Any coating method (e.g., chemical vapor deposition, physical vapor deposition, spray coating, soaking) may be used to form the coating layer by using these elements, as long as the coating does not affect the physical properties of the anode active material. Since one in the art is easily able to understand it, the above will not be explained in detail below.

Meanwhile, the active material may be included to the extent that does not cause degradation of binding force with the current collector due to decrease in the volume with respect to the total weight of the electrode layer, or relative decrease in the amount of binder.

The conductive material 130 provides the electrode with conductivity (to enable easy transfer of the electrons necessary for the electrochemical reaction to occur) and plays the role of lubricant among the active material particles to thus improve plate expansion and life cycle.

Herein, the conductive material 130 may be implemented as metal from shape memory alloy, and Ti—Ni binary alloy (e.g., nitinol) may be the representative example thereof.

Alternatively, a shape memory alloy in the form of tertiary (or higher) alloy may be used, in which a third element (e.g., V, Cr, Mn, Co, Hf, Zr, Pd, Pt, Nb, Cu, Fe, etc.) is added to Ti—Ni binary alloy.

Depending on embodiment, several tens of types of the shape memory alloys may be used, which may be largely divided into nickels (Ni), coppers (Cu), and irons (Fe), or specifically divided into Cu—Zn—Ni, Cu—Al—Ni, Ag—Ni, Au—Cd, etc. combining Zn, Al, Au, or Ag.

The ‘shape memory alloy’ refers to a material with varying phase in accordance with the external energy (heat, magnetism, stress), and to be specific, the shape memory alloy varies between hard and soft physical properties according to the phase transformation of austenite and martensite. Further, under external stress, the stress-induced martensite transformation occurs, and with the removal of the stress, the alloy returns to autensite.

Accordingly, if the shape memory alloy is used as the conductive material, this will generate variation in the phase due to the stress occurred in response to the variation of the electrode volume and also absorb the stress. That is, damages to electrode can be minimized.

Alternatively, depending on need, an additive material (or conductive material) having the form of martensite or two co-existing phases (austenite, martensite) may be used from the start at certain temperatures.

The shape memory alloy may be made by melting (atomizing, arc melting, etc.), explosion (dry, wet), sintering, or resistance/spark sintering, and since these are well known in the art, further description thereof will be omitted for the sake of brevity.

Further, the conductive material 130 may be implemented in the form including the above-mentioned shape memory material added with a material that does not provide the effect of the shape memory alloy. This will be explained in detail below with reference to FIG. 1b.

Meanwhile, the shape of the conductive material 130 is not particularly limited. Accordingly, the conductive material 130 may have various shapes including granule, scale, fibrous phase, etc.

The binder 140 causes the active material particles to attach to each other and also to the current collector well.

The binder 140 may use, for example, polyvinylalcohol, carboxymethylcellulose, hydroxypropylcellulose, diacetylcellulose, polyvinylchloride, carboxylated polyvinylchloride, polyvinyldifluoride, polymer containing ethyleneoxide, polyvinylpyrrolidone, polyurethane, polytetrafluoroethylene, polyvinylidene fluoride, polyethylene, polypropylene, styrene-butadiene rubber, acrylated styrene-butadiene rubber, epoxy resin, or nylon, but not limited thereto.

The binder 140 may be mixed in the suitable amount with respect to the total weight of the electrode layer so as not to cause problem in the binding force or amount.

The grading of the particles of the electrode layer 100′ may be adjusted by grinding and then seiving.

Meanwhile, depending on needs, the electrode layer 100′ may include pores.

The pores within the electrode layer may be shaped by a conventional pore forming method. If the pores are formed by using pore forming agent, it is possible to adjust the size, distribution and porosity of the pores formed in the electrode layer in accordance with the size, content and treating method of the pore forming agent. Any pore forming agent may be unlimitedly used, as long as the agent is generally used for forming pores. To be specific, the pore forming agent may be NH4)2CO3, NH4HCO3, (NH4)2C2O4 which are volatilized by the heat treatment to form pores within the electrode layer and a mixture thereof, polymer such as poly(alkylenecarbonate), poly(alkyleneoxide), poly(dialkyltoxane), acrylate polymer which can be dissolved in non-aqueous organic solvent and eluted, or carbonate containing alkali metal such as Li2CO3, K2CO3, Na(CO3)2 which can be dissolved in acid and eluted.

The porosity of the electrode layer 100′ may be chosen so as not to negatively affect the regulation on the volume expansion and energy density.

Further, depending on embodiments, high-strength binder layer (not illustrated) may be placed on top of the electrode layer 100′. The high strength binder layer may include a high strength binder and a filler.

The high strength binder may be the one that has low melting point and thus can be high crystallized at low temperature to increase mechanical strength.

The high strength binder may use any selected from the group consisting of acrylate polymer, vinyl polymer, fluor polymer, amide polymer, cellulose polymer, amide-imide polymer, sulfone polymer, alkyleneoxide polymer, copolymer thereof and a mixture thereof. To be specific, the high strength binder may use any selected from the group consisting of polyvinylchloride, polyvinylidenefluoride, polyvinylideneflouride-hexafluoropropylene copolymer, polyvinylalcohol, polyimide, carboxymethylcellulose and a mixture thereof.

Further, the high strength binder layer may additionally include acrylic binder along with the high strength binder. The binder improves affinity to electrolyte which is penetrated into the high strength binder, to thus increase lithium ion conductivity.

In addition to the high strength binder and the filler, the high strength binder layer may additionally include lithium salt as an additive to improve battery characteristic at high rate.

An appropriate amount of lithium salt may be mixed in consideration of the ion conductivity, viscosity and liquidity of the electrode.

Further, the high strength binder layer may be formed to an appropriate thickness in consideration of the ion conductivity and electric conductivity of the electrode.

If the high strength binder layer is formed, superior life cycle can be obtained, since the volume expansion of the electrode layer and interfacial reaction with electrolyte at the plate are regulated.

Referring to FIG. 2, the electrode 100-1 may include a current collector 110, an active material 120, conductivity materials 130, 131, and a binder 140.

As illustrated in FIG. 1, a material with shape memory effect may be used as one 130 of the conductivity materials, while the other conductivity material 130 may use a material without the shape memory effect. By way of example, conductive polymer may be used as the conductivity material without shape memory effect. The polymer with electric conductivity may use, for example, poly(sulfurnitrile), polypyrrole, poly(p-phenylene), poly(phenylenesulfide), polyaniline, poly(p-phenylenevinylene), etc.

That is, the conductive materials 130, 131 may be implemented as the combination of the one 130 with the shape memory effect and the other 131 without the shape memory effect.

Since the constitution of the electrode 100-1 is almost identical to that illustrated in FIG. 1a, except for the use of the combination of the conductive materials 130, 131 in which one 130 has the shape memory effect and the other 131 which does not, the detailed description thereof will be omitted for the sake of brevity.

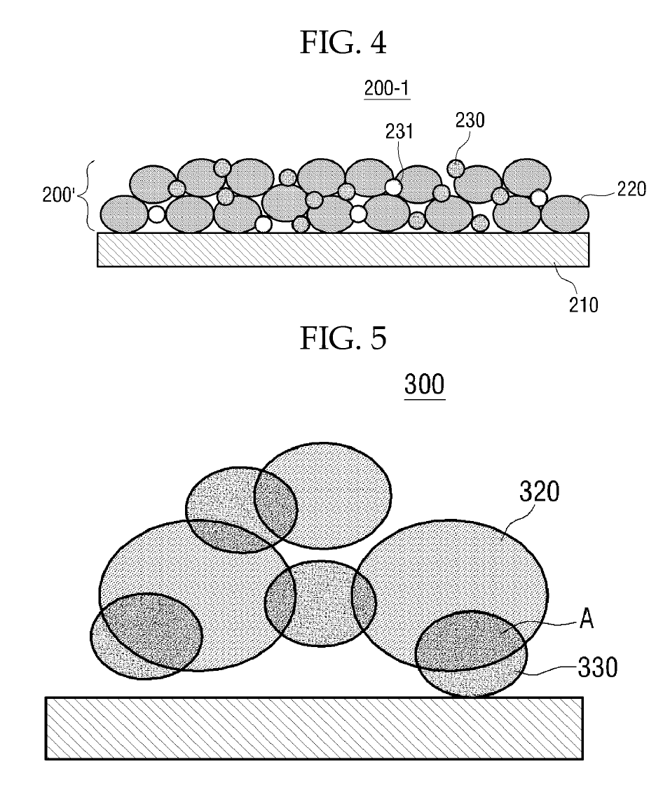

FIGS. 3 and 4 are vertical cross section views illustrating the electrode structure according to another embodiment of the present invention.

Referring to FIG. 3, the electrode 200 may include a current collector 210, an active material 220 and a conductivity material 230.

The constitution illustrated in FIG. 3 may be formed such that an electrode layer 200′ containing a mixture of the active material particles 220 and the conductive material particles 230 is spread on the current collector 210.

A metal from shape memory alloy may be used as the conductive material 230, and Ti—Ni binary alloy (e.g., nitinol) may be the representative example thereof.

Alternatively, a shape memory alloy in the form of tertiary (or higher) alloy may be used, in which a third element (e.g., V, Cr, Mn, Co, Hf, Zr, Pd, Pt, Nb, Cu, Fe, etc.) is added to Ti—Ni binary alloy.

Depending on embodiments, several tens of types of the shape memory alloys may be used, which may be largely divided into nickels (Ni), coppers (Cu), and irons (Fe), or specifically divided into Cu—Zn—Ni, Cu—Al—Ni, Ag—Ni, Au—Cd, etc. combining Zn, Al, Au, or Ag.

Referring to FIG. 4, the electrode 200-1 may include the current collector 210, the active material 220 and conductive materials 230, 231.

As illustrated in FIG. 3, a material with shape memory effect may be used as one 230 of the conductivity materials, while the other conductivity material 231 may use a material without the shape memory effect.

That is, the conductive materials 230, 231 may be implemented as the combination of the one 230 with the shape memory effect and the other 231 without the shape memory effect.

Since the constitution of the electrode 200-1 is almost identical to that illustrated in FIG. 1a, except for the use of the combination of the conductive materials 230, 231 in which one 230 has the shape memory effect and the other 231 which does not, the detailed description thereof will be omitted for the sake of brevity.

Meanwhile, since the constitutions illustrated in FIGS. 3 and 4 almost identical to those illustrated in FIGS. 1 and 2, except for the omission of the binder from the constitutions of FIGS. 1 and 2, detailed description thereof will be omitted for the sake of brevity.

FIG. 5 is a view illustrating constitution of an electrode layer composition according to an embodiment of the present invention.

Referring to FIG. 5, by forming the overlapping area A between the active material 320 and the conductive material 330 with a compound with non-reactivity or low reactivity to lithium by heat treatment, damages to electrode may be reduced.

By way of example, if Ni₃Si₂ is used as the active material 320 and TiNi is used as the conductive material 330, Ti—Si compound may e formed at the overlapping area A between the active material 320 and the conductive material 330. The Ti—Si compound has low reactivity to lithium so as to reduce damages to electrode.

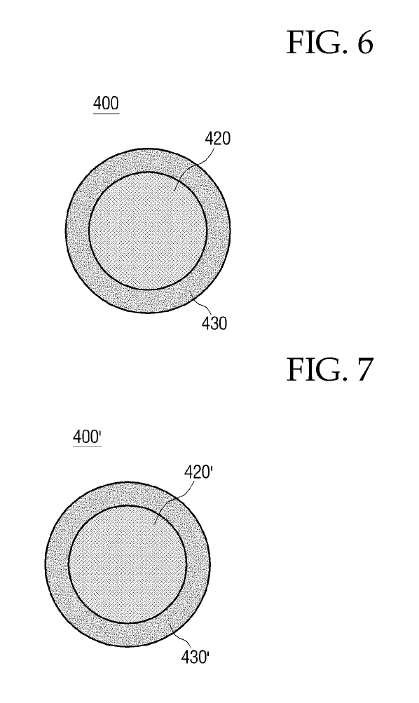

FIGS. 6 and 7 are views provided to explain constitution of an electrode layer composition according to another embodiment of the present invention.

Referring to FIG. 6, the electrode layer composition spread on the current collector may include a conductive material 430 coated on an active material particles (or powder) 420. A metal from shape memory alloy may be used as the conductive material 430 and Ti—Ni binary alloy (e.g., nitinol is the representative example thereof.

Alternatively, a shape memory alloy in the form of tertiary (or higher) alloy may be used, in which a third element (e.g., V, Cr, Mn, Co, Hf, Zr, Pd, Pt, Nb, Cu, Fe, etc.) is added to Ti—Ni binary alloy.

Depending on embodiment, several tens of types of the shape memory alloys may be used, which may be largely divided into nickels (Ni), coppers (Cu), and irons (Fe), or specifically divided into Cu—Zn—Ni, Cu—Al—Ni, Ag—Ni, Au—Cd, etc. combining Zn, Al, Au, or Ag.

Further, the active material composition 420 may use a material with lithium reversible reaction as explained above, or a material which can reversibly form a compound with lithium metal. Since the detailed example has been explained above, repetitious example thereof will be omitted for the sake of brevity.

Referring to FIG. 7, on the contrary to the constitution illustrated in FIG. 6, the electrode layer composition spread on the current collector may have a form in which the active material 420 is coated on the conductive particles (or powder) 430. Since the conductive material 430 and the active material 420 have been explained above, repetitious explanation thereof will be omitted for the sake of brevity.

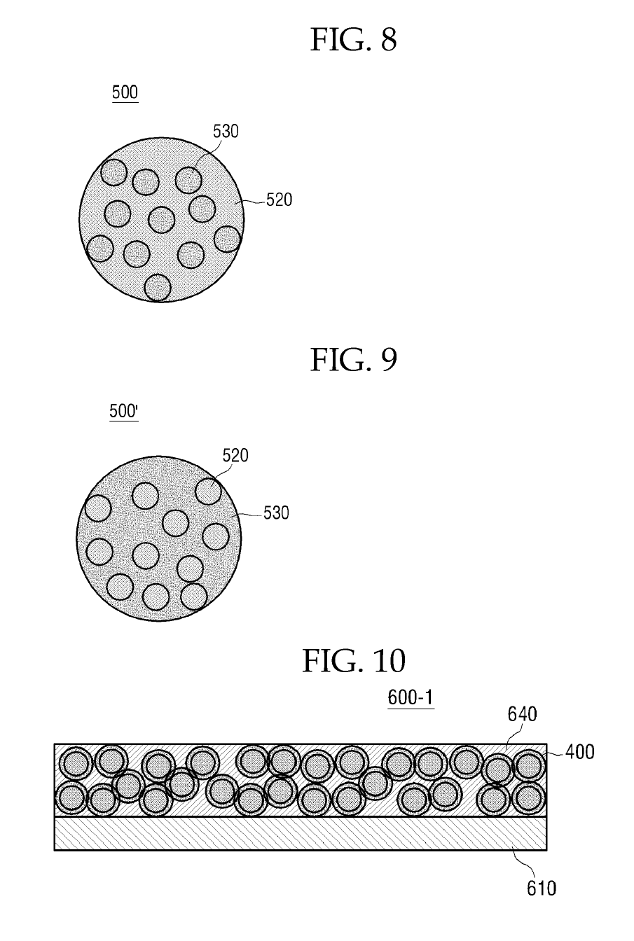

FIGS. 8 and 9 are views provided to explain constitution of the electrode layer composition according to another embodiment.

Referring to FIG. 8, an electrode layer composition 500 spread on the conductive material may have a form in which conductive material particles (or powder) 530 are dispersed in active material particles (or powder) 520.

Referring to FIG. 9, on the contrary to the constitution illustrated in FIG. 5a, an electrode layer composition 500′ spread on the current collector may have a form in which active material particles 520 are dispersed in the conductive material particles 530.

Further, the conductive material without shape memory effect as explained above may additionally be added to the conductive material 530 and the active material 520 illustrated in FIGS. 8 and 9.

FIGS. 10 to 12 are views provided to explain electrode constitution according to various embodiments of the present invention.

Referring to FIG. 10, an electrode 600-1 for use in lithium battery may include a current collector 610, active material particles 400 and a binder 640.

The active material particles 400 may take at least one of the forms illustrated in FIGS. 6 and 7.

Although FIG. 10 depicts the electrode layer having only one form (i.e., active material form according to FIG. 6), this is only provided for illustrative purpose. Accordingly, an electrode layer may be formed of a mixture of the active material particles illustrated in FIGS. 6 and 7.

Further, although one embodiment includes the binder 640, other embodiments are also possible. For example, the binder may be omitted, and the electrode may be constructed in the form in which the active material particles 400 alone are spread on the current collector 610.

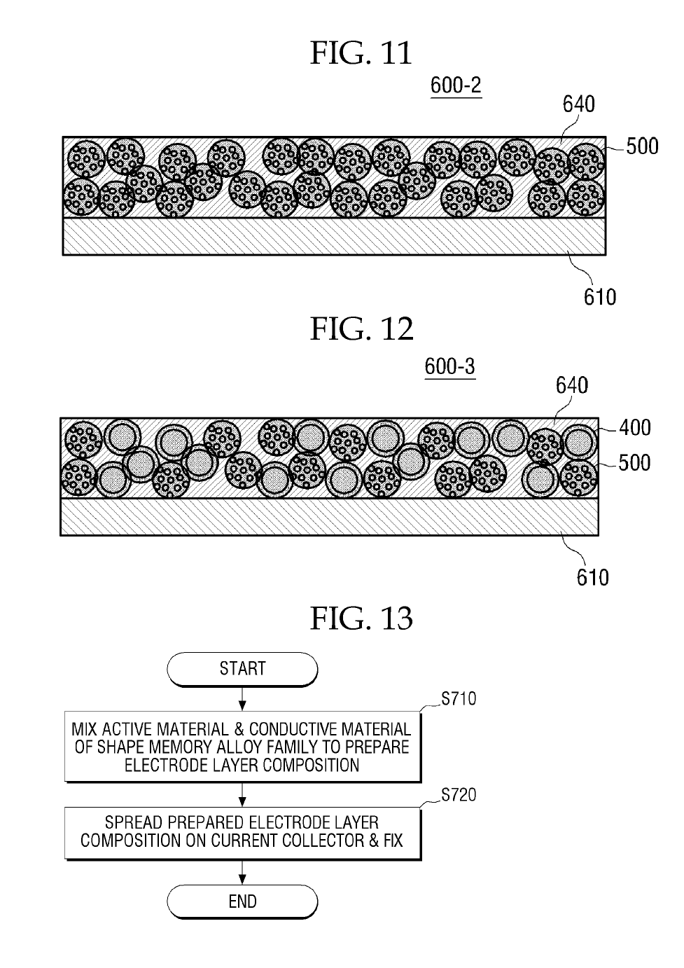

Referring to FIG. 11, an electrode 600-2 may include a current collector 610, active material particles 500, and a binder 640.

The active material particles 500 may take at least one of the forms illustrated in FIGS. 5a and 5b.

Further, although FIG. 11 depicts the electrode layer in only one form (i.e., active material form according to FIG. 8), this is written only for illustrative purpose. Accordingly, the electrode layer may consist of a mixture of the active material particles illustrated in FIGS. 8 and 9.

Further, while the binder 640 may be included according to one embodiment, this is written only for illustrative purpose. Accordingly, the binder may be omitted, and the electrode may take the form in which only the active material particles 500 are spread on the current collector 610.

Referring to FIG. 12, an electrode 600-3 may include a current collector 610, active material particles 400, 500 and a binder 640.

The active material particles 400, 500 may consist of a mixture of at least one of the forms illustrated in FIGS. 7 and 8, and at least one of the forms illustrated in FIGS. 8 and 9.

Although not illustrated, the electrode may also consist of a mixture of the active materials and the conductive materials illustrated in FIGS. 1, 2 and 3, 4, at least one form of the active material particles illustrated in FIGS. 6 and 7, and at least one form of the active material particles illustrated in FIGS. 8 and 9.

Further, while the binder 640 may be included according to one embodiment, this is written only for illustrative purpose. Accordingly, the binder may be omitted, and the electrode may take the form in which only the active material particles 400, 500 are spread on the current collector 610.

Further, as explained with reference to FIGS. 1 to 9, a conductive material without shape memory effect may additionally included in the electrode layer illustrated in FIGS. 10 to 12.

Meanwhile, the embodiments illustrated in FIGS. 8 and 9, and FIGS. 10 to 12 are written only for illustrative purpose and other embodiments are possible. Accordingly, the electrode active material and conductive polymer may be mixed with each other by various other methods including polymerization, synthesis, substitution, or the like.

FIG. 13 is a flowchart provided to explain an electrode fabricating process according to an embodiment of the present invention.

Referring to FIG. 13, at S710, an active material and a conductive material from shape memory alloy are mixed with each other to form an electrode layer composition. The conductive material from the shape memory alloy may be TiNi metal, for example. Since this is explained in detail above, repetitious explanation will be omitted for the sake of brevity.

Further, it is possible to prepare the electrode layer composition by additionally mixing the binder. The active material and the conductive material may be in powder form. To be specific, the electrode layer composition may take at least one of the forms illustrated in FIGS. 1 to 12.

According to embodiments, a conductive material without shape memory effect may be additionally included.

At S720, the electrode layer composition is spread on the current collector and fixed. Depending on needs, heat treatment may additionally be carried out.

As used herein, the ‘spreading’ may be carried out according to the viscosity of the composition of the electrode layer, and selected from the group consisting of screen printing, spray coating, coating with doctor blade, gravure coating, deep coating, silk screening, painting, slot die, aerosol deposition, and a combination thereof, but not limited thereto.

Further, the fixing may include fixing the mixed materials on the current collector by sintering or hot pressing, but not limited thereto. As used herein, the ‘sintering’ may refer to a method of heating the press-shaped material into tight and close contact into a caked form. The ‘hot pressing’ employs pressing while heating.

Meanwhile, the heat treatment of the active material and conductive material may be utilized, and the stacking and fixing processes may be integrated into one process.

Further, drying process may be carried out. The drying process may be conventional process including natural drying, hot air drying, etc.

Depending on embodiment, pores may be formed within the electrode layer.

The process of forming pores may be carried out by heating the electrode consisting of the electrode layer spread on the current collector. That is, since the electrode is heat-treated, the binder with lower melting point is gasified, leaving appropriate pores.

Alternatively, the pores may be formed by using pore forming agent. The pore forming agent may use a pore forming agent volatized by the heat treatment within the electrode layer, pore forming agent eluted by non-aqueous organic solvent or acid, but not limited thereto. In one embodiment, appropriate removal may be carried out depending on the types of the pore forming agent used.

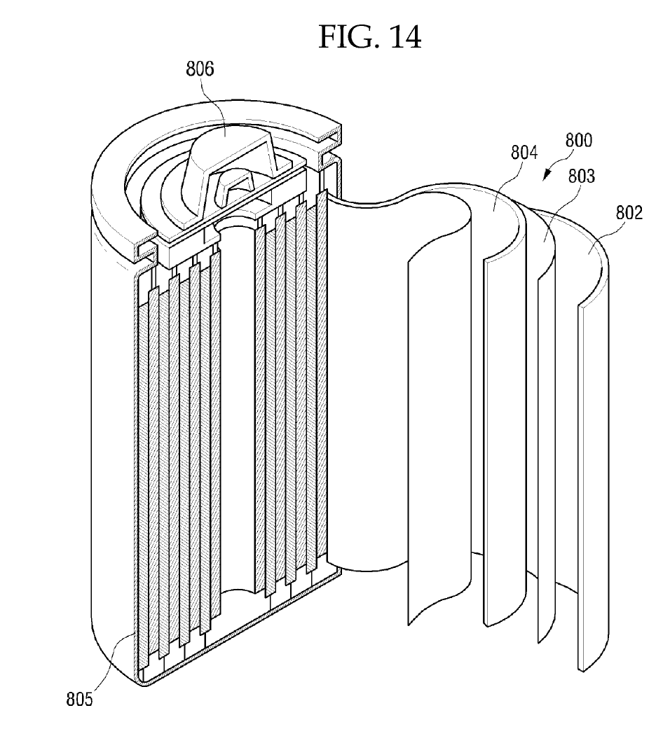

FIG. 14 is a view illustrating the constitution of the battery according to an embodiment of the present invention.

Referring to FIG. 14, a battery 800 according to an embodiment may include a cathode 802, an anode 804, a battery container 805 containing electrode infiltrating in a separator 803 present between the cathode 802 and the anode 804, a sealing member 806 for sealing the battery container 805. In one example, the battery 800 may be lithium secondary battery. However, this should not be construed as limiting. Accordingly, the battery 800 may be a battery using group 1 or 2 alkali metals. For example, the battery may use the group 1 element such as H, Li, Na, K, Rb, Cs, Fr, or group 2 element such as Be, Mg, Ca, Sr, Ba, Ra, or Ni or Pb. However, an example of lithium battery is explained for convenience of explanation.

The cathode 802 and the anode 804 may take the form of the electrode explained above.

Meanwhile, although the battery 800 of FIG. 14 includes the separator 803, the separator 803 may be omitted particularly if the cathode electrode includes high strength binder layer.

Depending on the types of the separator and the electrolyte used, the battery 800 may be categorized into lithium ion battery, lithium ion polymer battery and lithium polymer battery, and also be categorized into cylinder, square, coil, or pouch depending on the shape thereof. Also, the battery 800 may be categorized into bulk and membrane types according to size thereof.

Since the cathode 802 and the anode 804 are well explained above, repetitious explanation thereof will be omitted for the sake of brevity.

Thin film or bulk form of materials may be used as the electrolyte. While solid inorganic electrolyte or organic polymer electrolyte is generally used for the actual implementation of the device, liquid electrolyte is more often used for test purposes.

The electrolyte may contain lithium salt and non-aqueous organic solvent.

The lithium salt refers to a material which is dissolved in organic solvent, applied as a source of lithium ion in the battery to enable basic operation of the lithium ion battery and facilitate migration of the lithium ion between anode and cathode.

The lithium salt may be selected from the group consisting of LiPF6, LiBF4, LiSbF6, LiAsF6, LiClO4, LiCF3SO3, LiC4F9SO3, LiN(CF3SO2)2, LiN(C2F5SO2)2, LiAlO2, LiAlCl4, LiN(CpF2p+1SO2)(CqF2q+1SO2) (where, p and q are natural number), LiSO3CF3, LiCl, LiI, lithium bisoxalate borate and a mixture thereof, but not limited thereto.

The non-aqueous organic solvent applies as a medium through which ions involved in the electrochemical reaction of the battery move. The example of the non-aqueous organic solvent includes carbonate, ester, ether, catone, alcohol or nonprotonic solvent.

The non-aqueous organic solvent may be used in singular form or as a mixture of one or more. When used as a mixture of one or more, it is possible to appropriately adjust the mixing ratio according to targeting battery performance, and since this is well understandable by those skilled in the art, detailed explanation thereof will be omitted for the sake of brevity.

The separator 113 may be provided between the anode and the cathode depending on the type of the lithium battery. The separator 803 separates the cathode 802 and the anode 804 from each other, and provides a passage for the lithium ion. Any separator generally used in the lithium battery may be used. To be specific, the separator with low resistance against ionic migration of the electrolyte, and good electrolyte infiltration ability may be preferably used. By way of example, polyethylene, polyester, polypropylene, polyvinylidene fluoride or multi-layer having two or more layers of the above may be used, or a mixed multi-layer including two-layered polyethylene/polypropylene separator, three-layered polyethylene/polypropylene/polyethylene separator, or three-layered polypropylene/polyethylene/polypropylene separator may also be used.

Meanwhile, while the secondary battery may take the cylindrical form as illustrated in FIG. 14, this is provided only for illustrative purpose. Accordingly, the secondary battery may take other forms including cylinder, square, coin, pouch, or sheet.

As explained above, the separator may be arranged between the anode plate and the cathode plate to form a battery structure. The battery structure is wound or folded, and placed into a cylindrical or square battery casing, and the lithium ion battery is completed as the organic electrolyte is injected. Further, lithium ion polymer battery may be prepared by stacking the battery structure into bi-cell structure, infiltrating with the organic electrolyte, and placing the result into a pouch and sealing the same.

Accordingly, by using a compound with non-reactivity or low reactivity to lithium as a material for the electrode layer, the damages to the electrode due to volume variation of the electrode can be minimized. To be specific, by using the shape memory alloy as the conductive material, damages to the electrode can be minimized since it is possible that phase varies in response to the stress as it is generated due to volume variation of the electrode and the stress is absorbed. As a result, battery life cycle is lengthened.

While the embodiments using the electrode for lithium battery are explained above, this should not be construed as limiting. Accordingly, the electrode may also be used for the battery using other alkali metals. By way of example, the electrode may be used for the battery that uses group 1 element including H, Na, K, Rb, Cs, Fr, or group 2 element including Be, Mg, Ca, Sr, Ba, Ra, or Ni or Pb.

The foregoing embodiments and advantages are merely exemplary and are not to be construed as limiting the present invention. The present teaching can be readily applied to other types of apparatuses. Also, the description of the exemplary embodiments of the present inventive concept is intended to be illustrative, and not to limit the scope of the claims, and many alternatives, modifications, and variations will be apparent to those skilled in the art.

### INDUSTRIAL APPLICABILITY

1. An electrode comprising:
a powdered active material; and
a conductive material of a shape memory alloy family.

2. The electrode of claim 1, further comprising at least one of a binder and a conductive material without shape memory effect.

3. The electrode of claim 1, wherein the active material is formed such that one of the powdered active material and the conductive material is coated on an external surface of the other.

4. The electrode of claim 1, wherein the active material is formed such that one of the powdered active material and the conductive material is dispersed and included within the other.

5. The electrode of claim 3, wherein the active material is formed such that the conductive material without shape memory effect is formed at least one of interior and exterior thereof.

6. The electrode of claim 4, wherein the active material is formed such that the conductive material without shape memory effect is formed at least one of interior and exterior thereof.

7. The electrode of claim 1, wherein the electrode is used for a lithium or alkali battery.

8. The electrode of claim 2, wherein the electrode is used for a lithium or alkali battery.

9. The electrode of claim 3, wherein the electrode is used for a lithium or alkali battery.

10. The electrode of claim 4, wherein the electrode is used for a lithium or alkali battery.

11. A method for fabricating an electrode for use in a lithium battery, the method comprising:
mixing a powdered active material and a conductive material of a shape memory alloy family; and
forming an electrode layer using the mixed materials.

12. The method of claim 11, wherein the mixing comprises adding at least one of a binder and a conductive material without shape memory effect.

13. The method of claim 11, wherein the active material has at least one of a form in which one of the powdered active material and the conductive material is coated on an external surface of the other, or a form in which one of the powdered active material and the conductive material is dispersed and included within the other.

14. The method of claim 13, wherein the active material is formed such that the conductive material without shape memory effect is formed at least one of interior and exterior thereof.
